(19) United States
(12) Patent Application Publication
(10) Pub. No.: US 2026/0179236 A1
(43) Pub. Date: Jun. 25, 2026

(54) SYSTEM AND METHOD OF GENERATING BACKWARD OPTICAL FLOW DATA FROM FORWARD VELOCITY AND DEPTH INFORMATION

(71) Applicant: ATI Technologies ULC, Markham (CA)

(72) Inventor: Yubao Zheng, Markham (CA)

(73) Assignee: ATI Technologies ULC, Markham (CA)

(21) Appl. No.: 18/999,897

(22) Filed: Dec. 23, 2024

(51) Int. Cl. G06T 7/269; G06T 7/246

(52) U.S. Cl. CPC G06T 7/269; G06T 7/246; G06T 2207/10016

(57) ABSTRACT

A technique for generating backward optical flow data includes identifying a forward velocity value of a picture element at first coordinates in a subsequent frame buffer that stores forward velocity values for a subsequent frame. The technique identifies second coordinates in a previous frame buffer that stores backward velocity values of a previous frame by adjusting the first coordinates based on a negated version of the forward velocity value. A backward velocity value for the picture element at the second coordinates in the previous frame buffer is set to the negated version of the forward velocity value of the picture element at the first coordinates in the subsequent frame buffer. An image is rendered in accordance with the backward velocity value for the picture element at the second coordinates in the previous frame buffer.

### BACKGROUND

In graphics processing, the forward optical flow corresponds to the estimated motion of objects from a frame earlier in time to a frame later in time in, for example, a video or animation. The forward optical flow estimates the displacement of pixels as time moves forward, and has been used for different applications such as video compression, motion tracking, and frame interpolation. In contrast to forward optical flow, backward optical flow is an estimate of movement from a frame later in time back to a frame earlier in time.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1, illustrating additional detail;

FIG. 3 is a block diagram of a system for generating forward optical flow data, according to an example;

FIG. 4 illustrates aspects of a technique for generating backward optical flow data, according to an example;

FIG. 5 illustrates a further aspect of a technique for generating backward optical flow data, according to an example;

FIG. 6 illustrates a still further aspect of a technique for generating backward optical flow data, according to an example; and

FIG. 7 is a flow diagram illustrating a technique for generation of backward optical flow data, according to a further example.

### DETAILED DESCRIPTION

Frame generation techniques are used to achieve higher frame rates for graphics processing applications such as gaming. Such frame generation techniques often require both forward and backward optical flow data; however, some techniques for generating backward optical flow data are deficient. For example, simply reversing the optical flow from a subsequent frame may be inaccurate and/or result in a misalignment between the image and the optical flow. In addition, some techniques for estimating backward optical flow require significant computing power, and/or fail to adequately consider occlusions, e.g., where one object is blocked from view by another object that is closer to the camera. This disclosure describes improved techniques for generating higher quality backward optical flow data. In this disclosure, the terms optical flow and velocity are used interchangeably.

In the disclosed techniques, backward optical flow data is generated from forward velocity information output, for example, by a physics engine and/or graphical rendering pipeline. The forward velocity information corresponds to the rate at which a picture element (or a group thereof) moves in a particular direction between frames as time moves forward. The disclosed technique for generating backward optical flow data includes identifying a forward velocity value of a picture element at first coordinates in a subsequent frame buffer that stores forward velocity values for the subsequent frame. The technique identifies second coordinates in a previous frame buffer used to store backward velocity values of the previous frame by adjusting the first coordinates based on a negated version of the forward velocity value. A backward velocity value for the picture element at the second coordinates in the previous frame buffer is set to the negated version of the forward velocity value of the picture element at the first coordinates in the subsequent frame buffer. An image is rendered in accordance with the backward velocity value for the picture element at the second coordinates in the previous frame buffer.

In some examples, the techniques compare a mask element value associated with the second coordinates to a depth value associated with the picture element at the second coordinates. Based on a result of the comparing, the backward velocity value for the picture element at the second coordinates in the previous frame buffer is set to the negated version of the forward velocity value of the picture element at the first coordinates in the subsequent frame buffer. In some examples, this comparing results in the setting of the backward velocity value for the picture element in the previous frame buffer to a value associated with a picture element having a depth value closest to a camera position.

In some examples, the mask element value is initialized to a threshold prior to setting the backward velocity value for the picture element at the second coordinates in the previous frame buffer to the negated version of the forward velocity value of the picture element at the first coordinates in the subsequent frame buffer, and the mask value is later updated to reflect the depth associated with the picture element at the second coordinates.

In some examples, the system initializes a mask buffer having a plurality of mask elements, where the mask elements correspond in number and position to picture elements in the previous frame buffer that stores backward velocity values of the previous frame.

In some examples, the system uses the backward velocity value for the picture element in the previous frame buffer to predict frames that are displayed between other rendered frames and/or to increase the frame rate of displayed images.

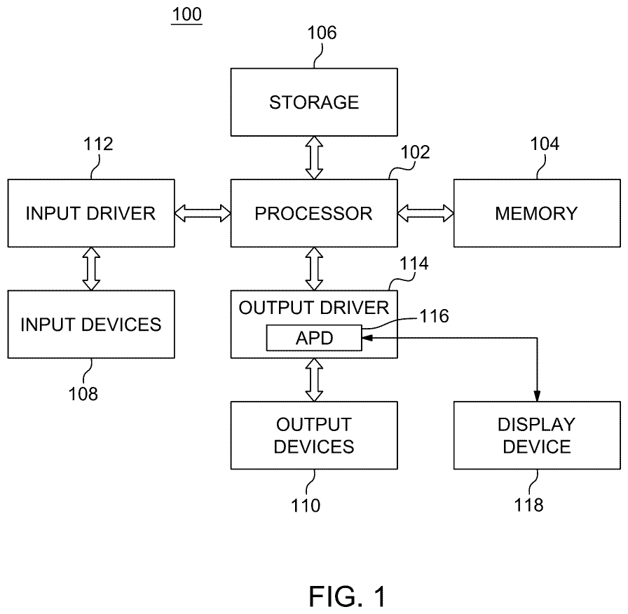

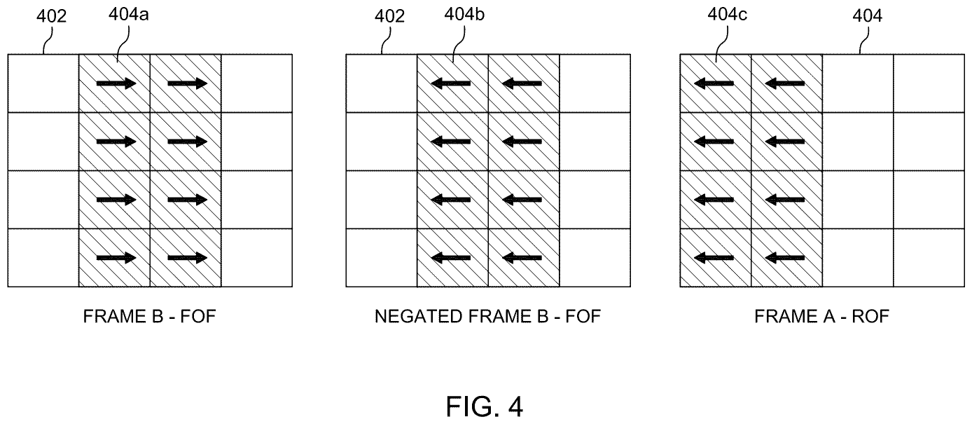

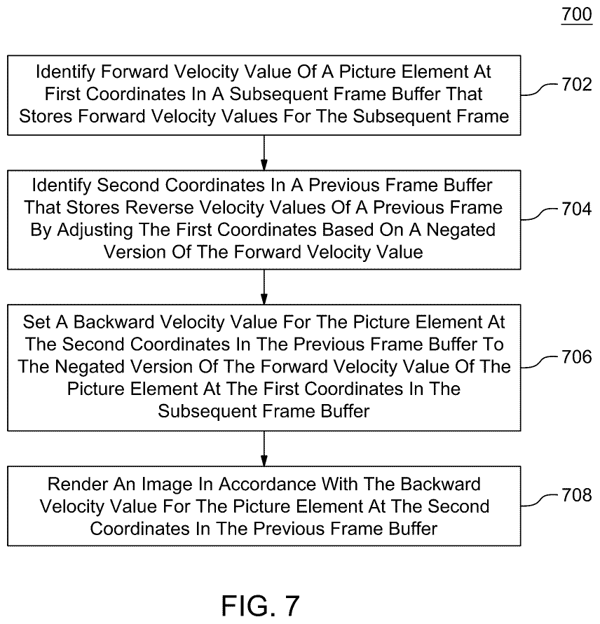

In the present disclosure, FIGS. 1-3 depict an exemplary system for implementing techniques disclosed herein for generating backward optical flow data. FIGS. 4-6 illustrate aspects of a technique for generating backward flow data, according to an example. FIG. 7 is a flow diagram illustrating a technique for generation of backward flow data, according to a further example.

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein.

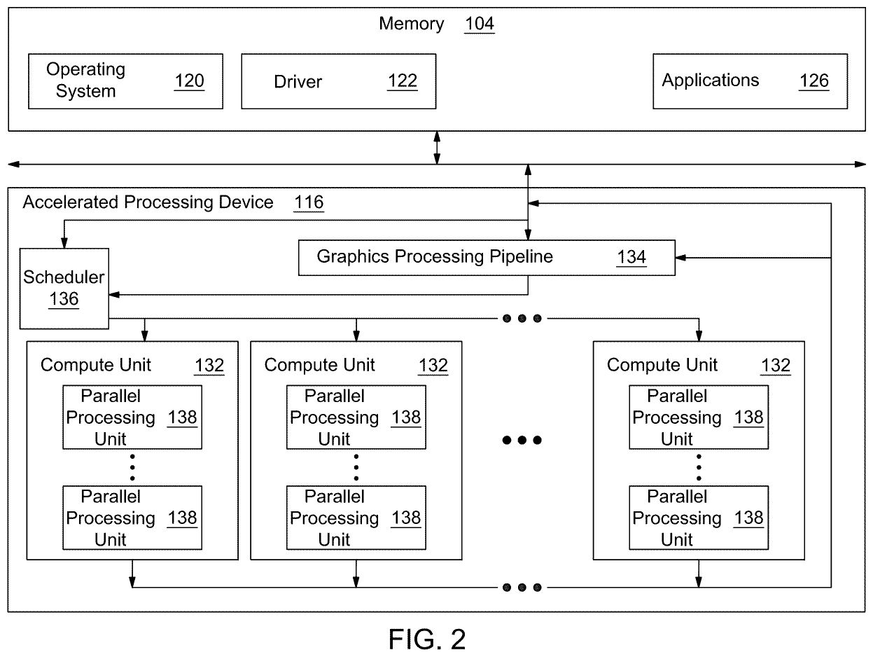

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps”. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel. Once pixel value calculations and other rendering tasks are completed, the final pixel data is stored in a frame buffer associated with the graphics pipeline 134. This frame buffer temporarily holds the fully rendered image data, allowing it to be displayed on a screen in subsequent processing stages. Systems that use frame generation techniques to achieve higher frame rates can include multiple frame buffers to store different stages of rendered frames, such as a previous frame buffer and a subsequent frame buffer. These frame buffers are used to hold optical flow information for the last frame (previous frame) and the next frame in the sequence (subsequent frame), enabling computations that rely on both forward and backward optical flow data. While these frame buffers may occupy the same area or separate areas in memory, the frame buffers are a hardware element that provides storage for frames needed by the graphics pipeline at different points in time.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

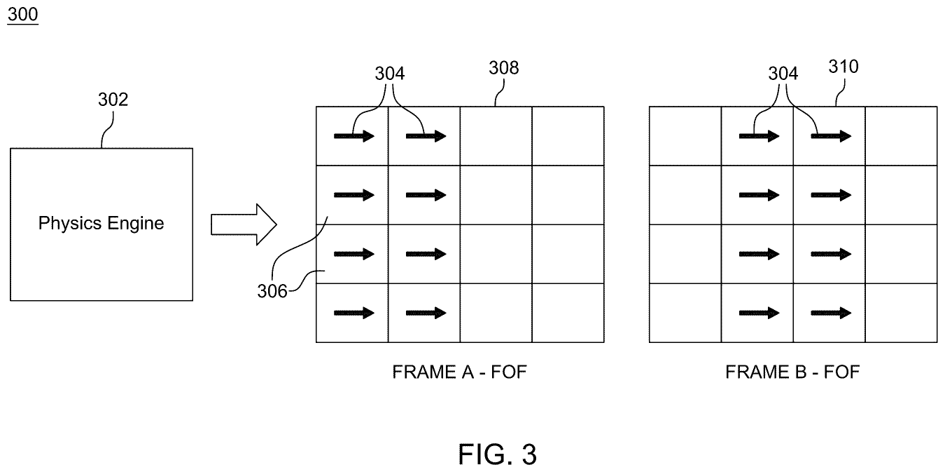

FIG. 3 is a block diagram of a system 300 for generating forward optical flow data, according to an example. Physics engine 302 (implemented, e.g., in software on processor 102) outputs forward optical flow information for image frames. Exemplary optical flow information for frames A and B includes motion vectors 304, which characterize the forward motion of picture elements 306 between frames. In one example, the forward optical flow (“FOF”) information for frame A is stored in buffer 308 (referred to as the “Frame A-FOF” buffer), and the forward optical flow information for frame B is stored in buffer 310 (referred to as the Frame B-FOF buffer). The forward optical flow information includes information indicating both the direction and velocity of motion for each picture element. In some examples, each picture element corresponds to a single pixel, while in other examples each picture element corresponds to a block of pixels or a group of pixels depicting an object in the frame. In some examples, the velocity of a picture element is expressed as a number of pixels that the picture element moves per unit of time or per frame. While not shown in the figure, processor 102 also outputs depth information (in the form of a depth buffer) for each frame, representing a distance from the camera corresponding to each picture element. In some examples, the forward optical flow information is generated by the physics engine 302 in world space (e.g., for 3D objects) and this information is subsequently translated into screen space (e.g., by a rendering pipeline) so that forward motion information is available for the picture elements. In some examples, the optical flow information for any given frame indicates movement from the immediately previous frame to the that given frame. In other words, in such examples, the optical flow information indicates how many pixel areas a particular pixel has moved from the immediately previous frame to the current frame.

The Frame A—FOF buffer 308 and the Frame B-FOF buffer 310 hold information that describes forward optical flow. For any given picture element of a frame, the forward optical flow indicates the forward movement of that picture element from the previous frame to that frame. For example, an item of forward optical flow for a picture element of frame A indicates the direction and magnitude of movement for that picture element from the prior frame to frame A. In a more concrete example, where the image includes a picture of a face and one picture element is the pupil of the eye, the forward optical flow data for a frame indicates the direction and magnitude of motion of the pupil element from a previous frame to that frame.

Each item of optical flow in a buffer (e.g., buffer 310) is at a particular location (e.g., picture element) in the frame and describes the motion of the picture element at that same location in the frame. In an example, frame A is followed by frame B. A picture element in frame A at coordinates x=10, y=20 has a corresponding item of forward optical flow data in the optical flow data buffer, and this item is also at coordinates x=10, y=20 in the optical flow data buffer. This item of forward optical flow data indicates that this pixel has moved to the right by 2 pixels to arrive at a that location, from the previous frame (e.g., frame A-1). Thus the picture element came from location x=8, y=20, and arrived at location x=10, y=20. In some examples frame A is before frame B in time. For example, frame B is the next frame output by, e.g., a physics engine, after frame A. In cases where frame B follows frame A in time, frame B is referred to as a subsequent frame with respect to frame A, and frame A is referred to as a previous frame with respect to frame B. As referred to herein, a previous frame buffer stores optical flow information for a previous frame, and a subsequent frame buffer stores optical flow information for a subsequent frame.

It is sometimes desirable to obtain the reverse (or backward) optical flow for a frame. The reverse optical flow indicates the reverse direction of motion for a picture element. More specifically, for a given frame, the reverse optical flow for a picture element should indicate how much that picture element moves to arrive at a location in a previous frame. In the example above, an item of reverse optical flow data for the picture element indicates that the picture element at location x=12, y=20 in frame B moves 2 pixels to the left to arrive at a particular location in Frame A.

FIG. 4 illustrates an aspect of a technique for generating backward flow data, according to an example. In one example, generation of backward optical flow data for Frame A begins by allocating a buffer 402, and, in some examples, populating each element in buffer 402 with the forward optical flow information for the corresponding picture element from Frame A-FOF buffer 310 (as shown in the left most buffer in FIG. 4). The system next loops through each picture element in buffer 402, and negates the forward optical flow information for each picture element. In the example of FIG. 4, the forward optical flow information for picture element 404a (illustrated for simplicity by a right arrow) indicates that picture element 404a moves 1 pixel to the right to arrive at frame B from frame A. The forward optical flow value of this picture element is negated by reversing the direction of the optical flow data to indicate that the picture element moves 1 pixel to the left. This negation is illustrated graphically in the center buffer in FIG. 4, where pixel 404b (at the same coordinates as pixel 404a) has a left arrow. It will be understood that in other examples the forward motion information includes a plurality of values, each of which is negated. For example, in a case where the forward optical flow information of a given pixel indicates motion 2 pixels to the right and 1 pixel down, the negated version of this motion information would indicate motion 2 pixels to the left and 1 pixel up.

Referring still to FIG. 4, the system next loops through each picture element in the buffer storing the negated forward optical flow information (shown in the center in FIG. 4), and maps such information to buffer 404, which stores the reverse optical flow (ROF) for frame A (referred to as Frame A-ROF)). In the mapping from the negated forward optical flow information (in the center in FIG. 4) to the Frame A-ROF buffer 404, the coordinates of each picture element in the negated Frame B-FOF buffer are adjusted by the amount(s) reflected by the negated forward optical flow information for such pixel. By way of example, the optical flow information for picture element 402b indicates motion 1 pixel to the left. Accordingly, the optical flow information for picture element 402b is mapped to picture element 404c in the Frame A-ROF buffer 404, which is at coordinates that are one pixel to the left of picture element 402b. Again, it will be understood that in other examples the negated forward motion information includes a plurality of values, each of which is used to adjust the coordinates of the optical flow information being mapped. For example, in a case where the negated forward optical flow information of a given pixel indicates motion 2 pixels to the left and 1 pixel up, such optical flow information would be mapped to the reverse optical flow buffer at coordinates that are two pixels to the left and 1 pixel up from the position of such information in the buffer storing the negated FOF information.

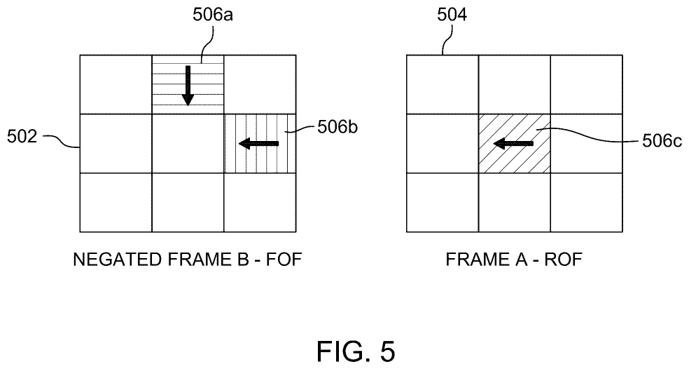

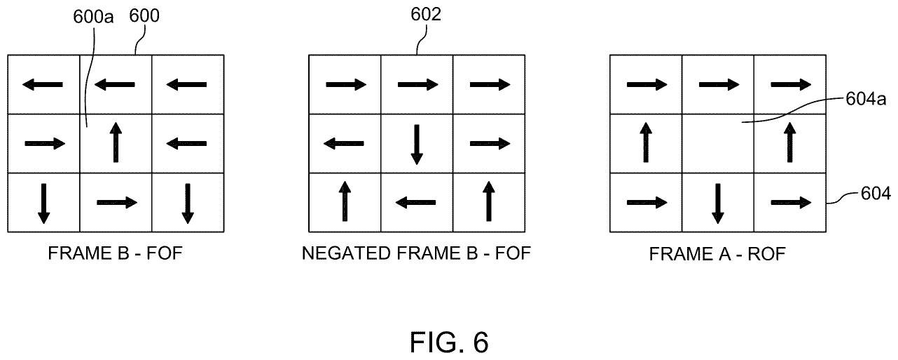

In connection with the mapping from the buffer storing the negated forward optical flow of frame B to the Frame A-ROF buffer 404 as shown in FIG. 4, it is possible that optical flow information corresponding to multiple picture elements in the buffer storing the negated forward optical flow of frame B will map to a common location in Frame A—ROF buffer 404. This scenario is shown graphically in FIG. 5, where the negated forward optical flow information stored in Negated Frame B—FOF buffer 502 from the picture elements at locations 506a and 506b in buffer 502 map to a single location 506c in the Frame A-ROF buffer 504. In order to address this scenario, the system checks the depth information associated with the picture element information stored at the locations 506a and 506b, and uses the reverse optical flow information associated with picture element with the least depth (the picture element closest to the camera) for mapping back to location 506c in Frame A-FOF buffer 504. In the example of FIG. 6, the picture element corresponding to location 506b had a smaller depth than picture element at location 506a. As a result, the reverse optical flow information associated with the picture element at location 506b is mapped back to the picture element at location 506b in buffer 504.

In one example, the system also allocates a further buffer, which in some examples is the same size as a depth buffer output for each frame by processor 102 or APD 116. In one example, this further buffer is referred to as an “Importance Mask.” In some examples, the value of each element in the Importance Mask is initially set to zero, although this is not necessary. The system tracks depth information associated with each picture element mapped to the Frame A—ROF buffer by updating the corresponding location in the Importance Mask buffer with the depth information of each pixel element as it is mapped back to the Frame A—ROF buffer. Before mapping back data to a particular location in the Frame A—ROF buffer, the system checks the depth value stored in the Importance Mask for the location and proceeds with the mapping only if the depth associated with the data to be mapped is less than (closer to the camera) the corresponding depth value stored in the Importance Mask. If this mapping occurs, then the value in the Importance Mask is updated with the depth value of the data to be (and that now has been) mapped.

In connection with the mapping from the Negated Frame B—FOF buffer to the Frame A-ROF buffer 404 (as shown, for example, in FIG. 4), it is also possible that optical flow information corresponding to no picture element in the negated Frame B FOF buffer maps to any picture element in the Frame A-ROF buffer 404. This scenario is illustrated in FIG. 6, where no optical flow information for any of the picture elements in the Negated Frame B—FOF buffer 602 maps to location 604a in Frame A—ROF buffer 604. If, after looping through each picture element in Negated Frame B—FOF buffer 602 and mapping the optical flow information from Negated Frame B—FOF buffer 600 into the adjusted location in Frame A—ROF 604 (using the technique described in connection with FIG. 4 above), there are any locations represented by the Importance Mask that are still set to the original initialized threshold value (e.g., zero in this example), the system will recognize that no optical flow information has been mapped to the corresponding location in the Frame A—ROF buffer 604. In such a situation, the system populates the location(s) missing optical flow data (e.g., location 604a in Frame A-ROF buffer 604 in FIG. 6) with the reverse of the forward optical flow information from the corresponding location(s) in the Frame B—FOF buffer 600 (e.g., location 600a shown in FIG. 6.).

FIG. 7 is a flow diagram illustrating a method 700 for generation of backward flow data, according to a further example. Prior to initiation of method 700, the system receives forward optical flow information (such as forward velocity information) for at least two frames (e.g., frames A and B, where Frame comes earlier in time than Frame B). In one example, the forward velocity information is output by a physics processor. In one example, the forward optical flow information for each frame is stored in its own buffer, and depth information for each frame (also output by, for example, a physics engine) is also stored in separate buffers. In some examples, the forward motion information includes information indicating both the direction and velocity of motion for each picture element. In some examples, each picture element corresponds to a single pixel, while in other examples each picture element corresponds to a block of pixels or a group of pixels depicting an object in the frame. In some examples, the velocity of a picture element is expressed as a number of pixels that the picture element moves per unit of time or per frame.

In step 702, the system identifies a forward velocity value of a picture element at first coordinates in a subsequent frame buffer that stores forward velocity values for a subsequent frame. For example, in the context of the example of FIG. 4, the system identifies the forward velocity value at location 404a in the Frame B—FOF buffer 402 (which stores forward optical flow information for frame B).

In step 704, the system identifies second coordinates in a previous frame buffer that stores backward velocity values of a previous frame by adjusting the first coordinates based on a negated version of the forward velocity value. For example, in the context of the example of FIG. 4, the system identifies the coordinates of location 404c by adjusting the coordinates corresponding to location 404a (or 404b) an amount corresponding to the negated version of the forward velocity value stored at location 402b (one pixel to the left of location 404b in the example shown).

In step 706, the system sets a backward velocity value for the picture element at the second coordinates in the previous frame buffer to the negated version of the forward velocity value of the picture element at the first coordinates in the subsequent frame buffer. For example, in the context of the example of FIG. 4, the system sets the velocity value for the picture element at location 404c of Frame A—ROF buffer 404 to the velocity value stored in location 404b of the Negated Frame B—FOF buffer. In one example, the system loops through steps 702-706 for each picture element in the subsequent frame buffer (e.g., Frame B—FOF buffer 402).

In step 708, the system renders an image in accordance with the backward velocity value for the picture element at the second coordinates in the previous frame buffer. For example, in the context of the example of FIG. 4, the system renders an image in accordance with the velocity information stored at location 404c of Frame A—ROF buffer 404.

In some examples, the system initializes values in a mask buffer (e.g., the buffer corresponding to the Importance Mask discussed above) to a threshold, such as zero. In one example, the mask buffer is the same size as a depth buffer output for each frame by processor 102. In some examples, as the system loops through each picture element in the subsequent frame buffer (e.g., Frame B—FOF buffer 402), the system compares the value stored in a location in the mask buffer to a depth value for a picture element being mapped to the same location in the previous frame buffer storing backward velocity values (e.g., Frame A—ROF buffer 404). If the depth associated with the data to be mapped is less than (closer to the camera) the corresponding depth value stored in the mask buffer, then the system proceeds to map the negated forward optical flow information to the previous frame buffer storing backward velocity values (e.g., Frame A—ROF buffer 404) and updates the corresponding depth value stored in the mask buffer to the lower depth value (closer to the camera); otherwise, the negated optical flow information is not mapped back to the previous frame buffer storing backward velocity values (e.g., Frame A—ROF buffer 404).

In one example, after looping through steps 702-706 for each picture element in the subsequent frame buffer (e.g., Frame B—FOF buffer 402). the system checks for any elements in the mask buffer still equal to the initialized threshold (e.g., zero) and for any corresponding picture element(s) in the previous frame buffer storing backward velocity values (e.g., Frame A—ROF buffer 404), sets the value to a negated version of the forward velocity value at the same location in the subsequent frame buffer that stores forward velocity values for the subsequent frame (e.g., Frame B—FOF buffer 404.)

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the parallel processing units 138) may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method, comprising:
identifying a forward velocity value of a picture element at first coordinates in a subsequent frame buffer that stores forward velocity values for a subsequent frame;
identifying second coordinates in a previous frame buffer that stores backward velocity values of a previous frame by adjusting the first coordinates based on a negated version of the forward velocity value;
setting a backward velocity value for the picture element at the second coordinates in the previous frame buffer to the negated version of the forward velocity value of the picture element at the first coordinates in the subsequent frame buffer; and
rendering an image in accordance with the backward velocity value for the picture element at the second coordinates in the previous frame buffer.

2. The method of claim 1, further comprising:
comparing a mask element value associated with the second coordinates to a depth value associated with the picture element at the second coordinates; and
based on a result of the comparing, setting the backward velocity value for the picture element at the second coordinates in the previous frame buffer to the negated version of the forward velocity value of the picture element at the first coordinates in the subsequent frame buffer.

3. The method of claim 2, further comprising:
updating the mask element value to the depth associated with the picture element at the second coordinates.

4. The method of claim 3, further comprising:
initializing the mask element value to a threshold prior to setting the backward velocity value for the picture element at the second coordinates in the previous frame buffer to the negated version of the forward velocity value of the picture element at the first coordinates in the subsequent frame buffer.

5. The method of claim 4, further comprising:
initializing a mask buffer having a plurality of mask elements, where the mask elements correspond in number and position to picture elements in the previous frame buffer that stores backward velocity values of the previous frame.

6. The method of claim 1, further comprising: using the backward velocity value for the picture element in the previous frame buffer to predict one or more frames displayed between other rendered frames.

7. The method of claim 4, wherein said setting of the backward velocity value for the picture element at the second coordinates in the previous frame buffer results in setting the backward velocity value for the picture element in the previous frame buffer to a value associated with a picture element having a depth value closest to a camera position.

8. The method of claim 7, wherein the threshold is zero.

9. A system comprising:
a memory configured to store picture element data; and
a processor configured to perform operations comprising:
identifying a forward velocity value of a picture element at first coordinates in a subsequent frame buffer that stores forward velocity values for a subsequent frame;
identifying second coordinates in a previous frame buffer that stores backward velocity values of a previous frame by adjusting the first coordinates based on a negated version of the forward velocity value;
setting a backward velocity value for the picture element at the second coordinates in the previous frame buffer to the negated version of the forward velocity value of the picture element at the first coordinates in the subsequent frame buffer; and
rendering an image in accordance with the backward velocity value for the picture element at the second coordinates in the previous frame buffer.

10. The system of claim 9, wherein the processor is further configured to perform:
comparing a mask element value associated with the second coordinates to a depth value associated with the picture element at the second coordinates; and
based on a result of the comparing, setting the backward velocity value for the picture element at the second coordinates in the previous frame buffer to the negated version of the forward velocity value of the picture element at the first coordinates in the subsequent frame buffer.

11. The system of claim 10, wherein the processor is further configured to update the mask element value to the depth associated with the picture element at the second coordinates.

12. The system of claim 11, wherein the processor is further configured to initialize the mask element value to a threshold prior to setting the backward velocity value for the picture element at the second coordinates in the previous frame buffer to the negated version of the forward velocity value of the picture element at the first coordinates in the subsequent frame buffer.

13. The system of claim 12, wherein the processor is further configured to initialize a mask buffer having a plurality of mask elements, where the mask elements correspond in number and position to picture elements in the previous frame buffer that stores backward velocity values of the previous frame.

14. The system of claim 9, wherein the processor is further configured to use the backward velocity value for the picture element in the previous frame buffer to predict one or more frames displayed between other rendered frames.

15. The system of claim 12, wherein said setting of the backward velocity value for the picture element at the second coordinates in the previous frame buffer results in setting the backward velocity value for the picture element in the previous frame buffer to a value associated with a picture element having a depth value closest to a camera position.

16. The system of claim 15, wherein the threshold is zero.

17. A non-transitory computer-readable medium storing instructions that, when executed by a processor, cause the processor to perform operations comprising:
identifying a forward velocity value of a picture element at first coordinates in a subsequent frame buffer that stores forward velocity values for a subsequent frame;
identifying second coordinates in a previous frame buffer that stores backward velocity values of a previous frame by adjusting the first coordinates based on a negated version of the forward velocity value;
setting a backward velocity value for the picture element at the second coordinates in the previous frame buffer to the negated version of the forward velocity value of the picture element at the first coordinates in the subsequent frame buffer; and
rendering an image in accordance with the backward velocity value for the picture element at the second coordinates in the previous frame buffer.

18. The non-transitory computer-readable medium storing instructions of claim 17, wherein said instructions that, when executed by a processor, further cause the processor to perform:
comparing a mask element value associated with the second coordinates to a depth value associated with the picture element at the second coordinates; and
based on a result of the comparing, setting the backward velocity value for the picture element at the second coordinates in the previous frame buffer to the negated version of the forward velocity value of the picture element at the first coordinates in the subsequent frame buffer.

19. The non-transitory computer-readable medium storing instructions of claim 18, wherein said instructions that, when executed by a processor, further cause the processor to update the mask element value to the depth associated with the picture element at the second coordinates.

20. The non-transitory computer-readable medium storing instructions of claim 19, wherein said instructions that, when executed by a processor, further cause the processor to initialize the mask element value to a threshold prior to setting the backward velocity value for the picture element at the second coordinates in the previous frame buffer to the negated version of the forward velocity value of the picture element at the first coordinates in the subsequent frame buffer.
